(19) United States
(12) Patent Application Publication
(10) Pub. No.: US 2002/0121161 A1
(43) Pub. Date: Sep. 5, 2002

(54) Fluid operated tool for tightening and loosening threaded connectors

(76) Inventor: Peter Koppenhoefer, Portland, PA (US)

Correspondence Address: Striker, Striker & Stenby, 103 East Neck Road, Huntington, NY, 11743, US

(21) Appl. No.: 09/799,455

(22) Filed: Mar. 5, 2001

(51) Int. Cl. B25B 13/46

(52) U.S. Cl. 81/57.39

(57) ABSTRACT

A fluid-operated tool has a ratchet link assembly provided with ratcheting mechanism for engaging and turning a threaded connector, a fluid-operated drive assembly releasably connectable with the ratchet link assembly, and a unit for releasably connecting the fluid operated drive assembly with the ratchet link assembly, the connecting unit including an opening provided in one of the assembly, a projection provided in the other of the assemblies and insertable into the opening, and a blocking member which block the projection in the opening in an assembled condition of the assemblies, the blocking member being operable by a user to unblock the projection and to allow withdrawal of the projection from the opening so as to release the assemblies from one another. The opening and the projection are formed so that in operation during an advance stroke of the fluid operated drive the projection is urged further into the opening.

### BACKGROUND OF THE INVENTION

The present invention relates to a fluid operated tool for tightening and loosening threaded connectors.

A fluid operated tool usually includes a fluid-operated drive assembly with a fluid operated cylinder-piston unit, and a ratchet link assembly provided with a ratchet mechanism connected with the fluid operated drive. It is desirable to connect the same fluid operated drive assembly to various ratchet link assemblies having various sizes of a hexagonal engaging part, for engaging threaded connectors of different hexagonal sizes. Connecting means usually include pins, screws, etc., which could fall out of the tool or could be lost. The loose pieces could also fall into an equipment where they could not be retrieved or can be retrieved with great difficulties. Usually the power industry equipment in which threaded connectors must be tightened or loosened is very sensitive to foreign materials and does not allow any foreign parts to be dropped into it.

### SUMMARY OF THE INVENTION

Accordingly, it is an object of present invention to provide a fluid-operated power tool which avoids the disadvantages of the prior art.

In keeping with these objects and with others which will become apparent hereinafter, one feature of present invention resides, briefly stated, in a fluid operated power tool which has a ratchet link assembly provided with a ratcheting mechanism for engaging and turning a threaded connector; a fluid-operated drive assembly releasably connectable with said ratchet link assembly; and means for releasably connecting said fluid operated drive assembly with said ratchet link assembly, said connecting means including opening means provided in one of said assemblies, projection means provided in the other of said assemblies so that the projection means can not be inadvertently lost from the other assembly and insertable into said opening means, and blocking means which block said projection means in said opening means in an assembled condition of said assemblies, said blocking means being operable by a user to unblock said projection means and to allow withdrawal of said projection means from said opening means so as to release said assemblies from one another.

In accordance with another feature of the present invention, said opening means and said projection means are formed so that in operation during an advance stroke of said fluid operated drive means said projection means is urged further into said opening means.

When the fluid operated power tool is designed in accordance with the present invention, it does not have loose pins or screws which fall out of the tool, get lost, or fall into equipment in which the threaded connectors has to be tightened or loosened.

In accordance with another important feature of the present invention, an intermediate element is provided between a piston rod of the fluid-operated drive assembly and a drive plate of the ratchet link assembly. It eliminates wear in a cylinder gland area of the fluid-operated drive assembly.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is an exploded view showing a fluid-operated tool with two assemblies that are to be connected with one another;

FIG. 2 is a view showing the assembled fluid-operated tool with the two assemblies in accordance with the present invention;

FIG. 3 is a view showing a section taken along the lines III-III in FIG. 2 and showing connections of the assemblies with one another;

FIGS. 4a, 4b, 4c are views showing three projections of a sliding element for a friction reduction between a drive plate and a piston rod; and

FIGS. 5 and 6 are views showing sections of the inventive tool in an area of the sliding member.

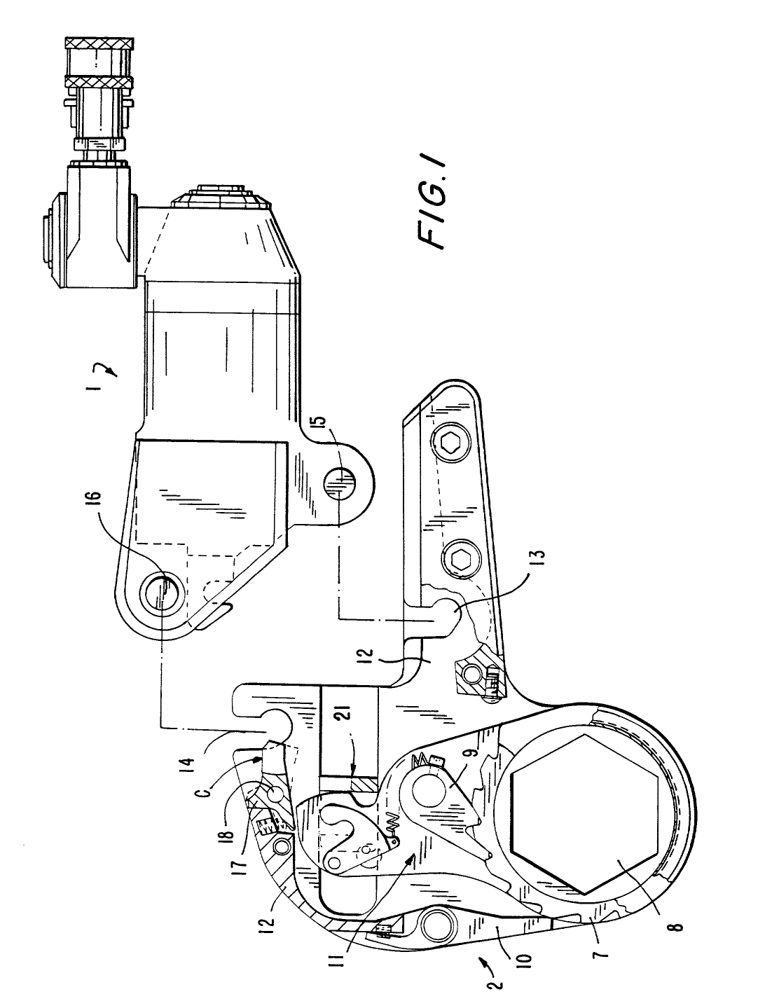

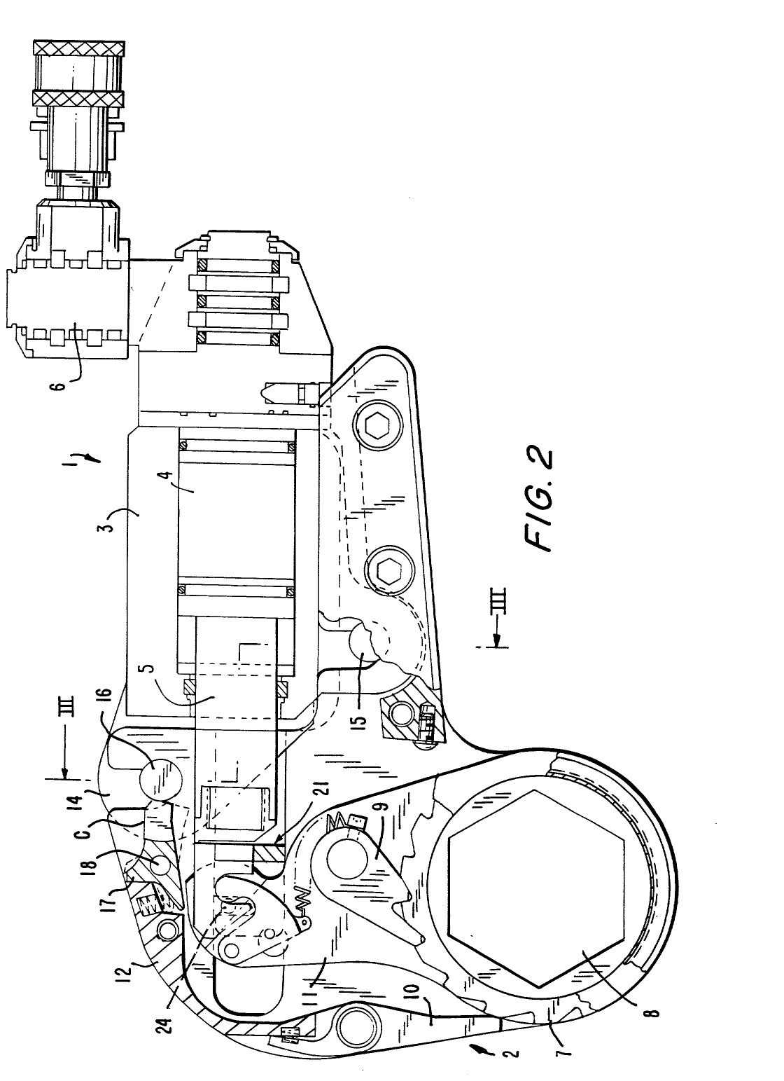

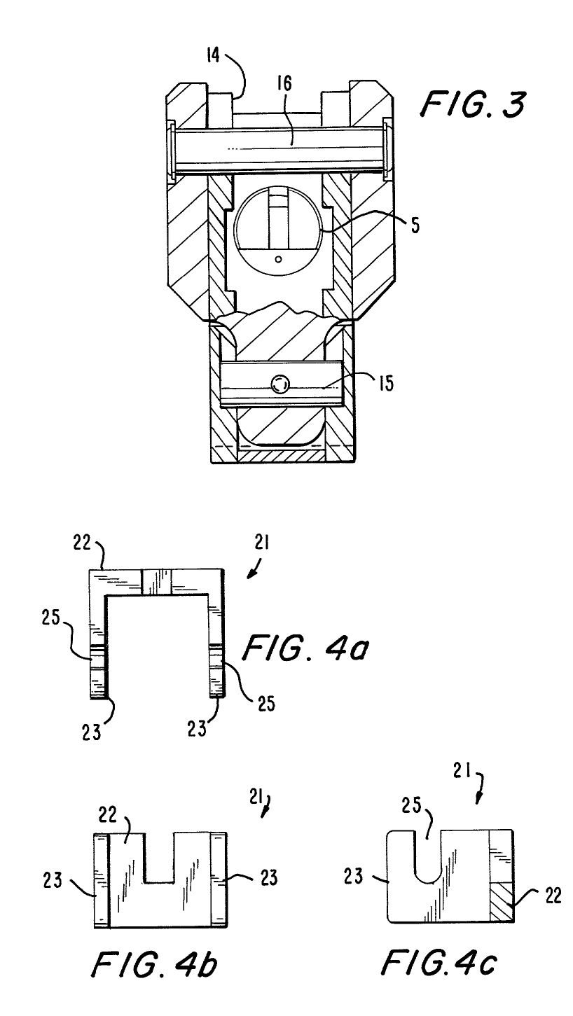

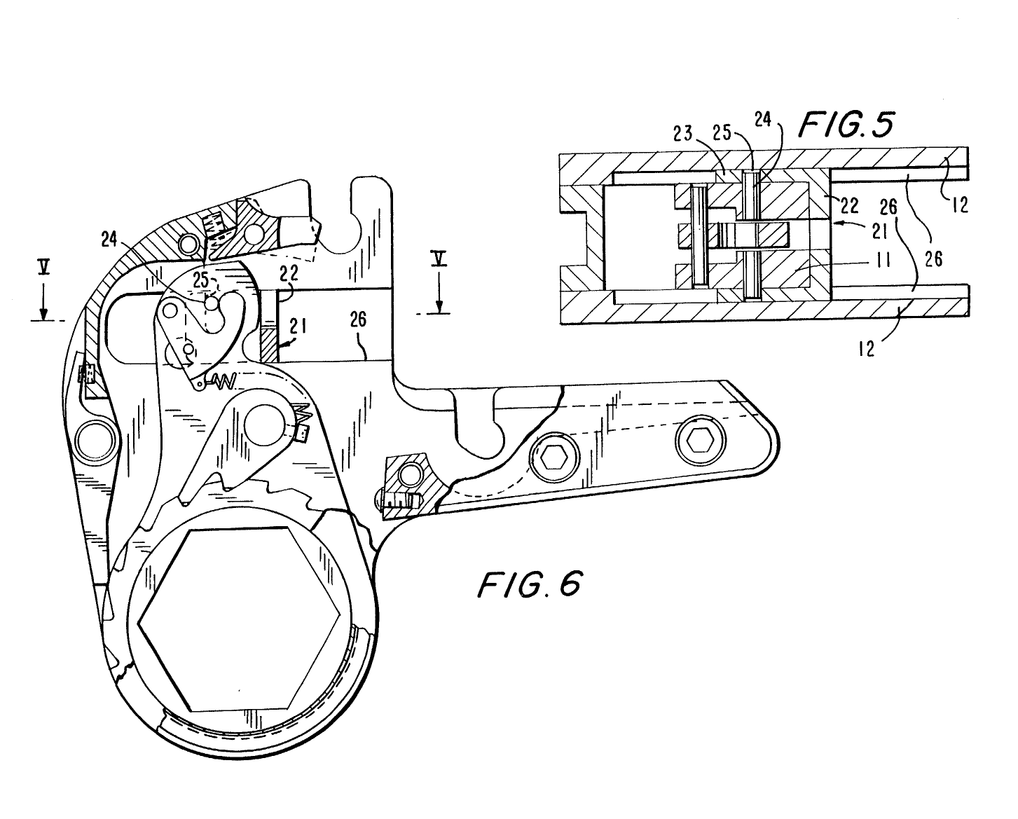

### DESCRIPTION OF PREFERRED EMBODIMENTS

A fluid operated tool in accordance with present invention has a fluid operated drive assembly which is identified as a whole with reference numeral 1. The drive assembly 1 has a cylinder 3 with a piston 4 which is movable in the cylinder and provided with a piston rod 5. A fluid connector 6 supplies fluid into and withdraws the fluid from corresponding chambers in the cylinder 3.

The fluid-operated tool piston has a ratchet link assembly 2 with a ratchet 7 provided with a formation for engaging the threaded connector, for example with a hexagonal opening 8. Two pawls 9 and 10 which engage the teeth of the ratchet 7. The pawl 9 is turnably mounted on a drive plate 11, while the pawl 10 is turnably mounted on a side plate 12 which forms a part of the housing. The end of the piston rod 5 engages the drive plate 11 directly or indirectly in its head part. While the piston rod 5 performs an advance stroke, the drive plate 1 together with the pawl 9 is turned so that the pawl 9 turns the ratchet 7 and therefore a threaded connector engaged in the hexagonal opening 8. During a return stroke of the piston rod 5 the pawl 9 slides over the teeth of the ratchet 7, while the pawl 10 holds the ratchet 7 from turning in an opposite direction. The above described construction of the fluid operated tool and its operation are well known in the art.

In accordance with the present invention, connecting means for connecting the fluid-operated drive assembly 1 with the ratchet link assembly 2 are provided. The connecting means include two pockets 13 which are formed in the side plates 12, in particular on their inner faces which face toward one another, and two slots 14 also provided in the side plates 12 at a location which is higher than the location of the pockets. The connecting means further include a pin 15 which is located in a lower opening of the body of the drive assembly 1, and a pin 16 which is located in an upper opening of the body of the drive assembly 1, so that the pins 13 and 16 can not be lost. For example, the pin 15 is non-releasably fixed by a central pin, and the pin 16 is non-releasably fixed by the securing ring. The pockets 13 extend only through a part of the thickness of the side plates 12 so as not to weaken the corresponding area of the side plates.

In order to connect the assemblies 1 and 2 with one another, the drive assembly 1 is lowered vertically, so that the pins 15 and 16 are inserted in the pockets 13 and slots 14 and reach the bottom of the pockets and slots. This position is secured by a spring-loaded latch which is identified with reference numeral 17 and is turnable around an axis 18. The right leg of the latch 18 reliably holds the pin 16 in the slots 14. In order to remove the drive assembly 1 from the ratchet link assembly 2, the latch 17 is turned by the depressing its right leg, for example manually, against the action of a spring, so that the pins 15 and 16 can be withdrawn from the pockets 13 and the slots 14, and the drive assembly 1 can be lifted and removed from the ratchet link assembly 2.

In the assembled condition, during an advanced stroke of the piston rod, the cylinder reaction force pushes the drive assembly 1 so that the pins 15 and 16 are pushed against the ends of the pockets 13 and the slots 14, to maintain and even to enhance the connection. During the reverse stroke of the piston rod, the reaction force is much smaller and therefore a tendency to pull the pins from the pockets of the slot does not endanger the connection. The latch 17 in the locking position and the interaction of the bottom of the drive assembly 1 with the ratchet link assembly 2 prevent the displacement of the pins from the slots and the pockets.

The fluid operated tool in accordance with the present invention is further provided with a wear reducing element which is identified as a whole with reference numeral 21. The wear reducing element 21 has a portion 22 which is located between an upper head part of the drive plate 11 and a part of the piston rod 5. The wear reducing element 21 can also have two legs 23 which are connected with the drive plate 11 by a pin 24 extending through drive plate and engaging into openings 25 of the legs 23. The thusly designed wear reducing member 21 has a U shape. It reduces a frictional force which is created on the interface of the drive plate 11 of the ratchet link assembly 2 and the piston rod 5 of the drive assembly 1. The wear reducing element 21 slides in slots 26 which are provided in inner surfaces of the side plates 12.

Since the wear reducing element 21 is guided in the slots of the side plates 12, a frictional force is now created between the wear reducing element 21 and the drive plate 12, thus eliminating a lateral force from the piston rod 5 which was generated in the prior art by frictional force between the drive plate and the piston rod.

It will be understood that each of the elements described above, or two or more together, may also find a useful application in other types of constructions differing from the types described above.

While the invention has been illustrated and described as embodied in a fluid operated tool for tightening and loosening threaded connectors, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A fluid-operated tool, comprising a ratchet link assembly provided with ratcheting mechanism for engaging and turning a threaded connector; a fluid-operated drive assembly releasably connectable with said ratchet link assembly; and means for releasably connecting said fluid operated drive assembly with said ratchet link assembly, said connecting means including opening means provided in one of said assemblies, projection means provided non-realeasably in the other of said assemblies and insertable into said opening means, and blocking means which block said projection means in said opening means in an assembled condition of said assemblies, said blocking means being operable by a user to unblock said projection means and to allow withdrawal of said projection means from said opening means so as to release said assemblies from one another.

2. A fluid-operated tool as defined in claim 1, wherein said opening means and said projection means are formed so that in operation during an advance stroke of said fluid operated drive means said projection means is urged further into said opening means.

3. A fluid-operated tool as defined in claim 1, wherein projection means is non-releasably connected with a corresponding one of said assemblies, said blocking means being also non releasably connected with a corresponding one of said assemblies.

4. A fluid-operated tool as defined in claim 1, wherein said projection means include at least one pin provided in at least one of assemblies, said opening means including at least one slot which is provided in the other of said assemblies and open outwardly of said other assembly so that said pin can be moved into said outwardly open slot.

5. A fluid-operated tool as defined in claim 1, wherein said blocking means is formed as a latch which is turnable about an axis and has a first end adapted to block said projection means in said opening means and located at one side of said axis, and another portion located at an opposite side of said axis.

6. A fluid-operated tool as defined in claim 5; and further comprising a housing, said other portion of said latch abutting against said housing.

7. A fluid-operated tool as defined in claim 6; and further comprising spring means which bias said latch to said blocking position.

8. A fluid-operated tool as defined in claim 1, wherein said ratchet assembly has access means for accessing to said blocking means for applying a force to said blocking means to move said blocking means from said blocked position in which it blocks said projection means in said opening means, to an unblocked position in which said projection means can be moved out of said opening means.

9. A fluid-operated tool as defined in claim 1, wherein said fluid operated drive assembly has a movable piston provided with a piston rod, said ratchet link assembly having a drive plate arranged so that said piston rod turns said drive plate so as to drive a ratchet of said ratchet link assembly and therefore to drive a fastener arranged by said ratchet; and further comprising an intermediate wear-reducing element provided between said piston rod and said drive plate.

10. A fluid-operated tool as defined in claim 9, wherein said ratchet link assembly has a slot, said intermediate element being arranged movably in said slot.

11. A fluid-operated tool as defined in claim , wherein said intermediate element is slidable relative to side plates of said ratchet link assembly.

12. A fluid-operated tool as defined in claim 10, wherein said side plates have slots, said intermediate element being slidable in said slots of said side plate.
